(19) United States
(12) Patent Application Publication
(10) Pub. No.: US 2014/0181951 A1
(43) Pub. Date: Jun. 26, 2014

(54) Method for Remotely Servicing a Field Device of Automation Technology

(71) Applicants: Rolf Birkhofer, (US); Michael Gunzert, (US); Robert Hartmann, (US); Thorsten Deuser, (US); Immanuel Vetter, (US)

(72) Inventors: Rolf Birkhofer, (US); Michael Gunzert, (US); Robert Hartmann, (US); Thorsten Deuser, (US); Immanuel Vetter, (US)

(21) Appl. No.: 14/107,013

(22) Filed: Dec. 16, 2013

(30) Foreign Application Priority Data
Dec. 21, 2012 (DE) 10 2012 112 875.8

(51) Int. Cl. H04L 29/06; H04L 29/08

(52) U.S. Cl. CPC H04L 63/0218; H04L 67/2809
USPC 726/12

(57) ABSTRACT

A method for remotely servicing a field device of automation technology located in a first network secured by a first firewall, wherein remote servicing occurs via a servicing device associated with a second network secured by a second firewall comprising the steps of: establishing a first communication connection between the field device and a gateway associated with the first network; establishing a second communication connection; reporting of the first gateway; granting a unique identifier by a broker server for the first communication connection; transmitting the unique identifier to a second gateway associated with the second network; establishing a third communication connection between the second gateway and the broker server using the unique identifier; and establishing a communication connection between the second gateway and the first gateway, wherein: the broker server logically connects the second communication connection and the third communication connection with one another, so that communication connection between the servicing device and the field device is produced.

The invention relates to a method for remotely servicing a field device of automation technology located in a first network secured by a first firewall, wherein remote servicing occurs via a servicing device associated with a second network secured by a second firewall.

In automation technology, especially in process automation technology, field devices are applied, which serve for registering and/or influencing process variables. Serving for registering process variables are sensors, which are integrated, for example, in fill level measuring devices, flow measuring devices, pressure- and temperature measuring devices, pH-redox potential measuring devices, conductivity measuring devices, etc., and register the corresponding process variables fill level, flow, pressure, temperature, pH-value, and conductivity, respectively. Serving for influencing process variables are actuators, such as, for example, valves or pumps, via which the flow of a liquid in a section of pipeline, respectively the fill level in a container, can be changed. Referred to as field devices are, in principle, all devices, which are applied near to the process and deliver or process information relevant to the process. In connection with the invention, the terminology “field devices” thus includes also remote T/Os, radio adapters, and, in general, any devices, which are arranged at the field level. A large number of such field devices are produced and sold by the firm, Endress+Hauser.

In modern industrial plants, communication between at least one superordinated control unit at the system level and the field devices on the field level occurs, as a rule, via bus systems. Applied at the field level are fieldbus systems such as, for example, Profibus® PA, Foundation Fieldbus® or HART®. An advantage of fieldbus systems is that they offer a high measure of safety and security. However, a disadvantage is that the data transmission rate is relatively low, so that communication is relatively slow.

Serving at the system level are superordinated control units for process control, process visualizing, process monitoring as well as for start-up and servicing of the field devices. These are also referred to as configuration/management systems. Programs, which run self-sufficiently on superordinated control units, include, for example, the operating, servicing tools FieldCare of the group of firms, Endress+Hauser, PACTware, AMS of Fisher-Rosemount and PDM of Siemens. Tools integrated into control system applications include PCS7 of Siemens, Symphony of ABB and Delta V of Emerson. Protocol conversion between the field level and the system level occurs via a so-called gateway.

Field devices of automation technology, especially process automation, usually use digital interfaces for servicing the field devices. The terminology ‘servicing field devices’ in connection with the invention means especially the configuring and parametering of field devices, however, also diagnosis and maintenance for the purpose of early detection of defects in the field devices or in the process. In the broadest sense, the concept “servicing” includes also simply the displaying of information.

In order to be able to utilize the digital interface, one needs, in general, to access the field device directly. A remote servicing of field devices is usually only possible in the technological context of the respective interface technology. FIG. 2 shows a known application for remote servicing of two field devices FD1, FD2 using the HART protocol via a two conductor connection. The service unit E1 is coupled for digital communication via a HART modem C1 into the two conductor connection, so that a data communication connection with the remotely arranged devices FD1, FD2 is established.

As already mentioned, gateways are used for data exchange beyond the limits of the fieldbus system, in order to expand the access radius by the transport of data via additional communication structures. The predetermined and usually also purposely enforced limit for remote servicing is, in general, the range of the LAN, thus the intranet range of the respective user, which is protected against access from the Internet by at least one firewall.

There are scenarios, in which limiting remote servicing to the respective LAN range is disadvantageous. Examples of such scenarios are listed as follows:

Advising customers in the case of malfunction of a field device: If there is a malfunction during operation of a field device, in general, a service technician must travel, in order to analyze the malfunction on-site. The necessary transit leads not only to increased costs, but also lengthens the reaction time unnecessarily.

Developing device-specific integration solutions, where on-site accessing of the field device is required: In order to integrate an automation field device into a superordinated system, it is necessary to develop integration means—thus technically readable descriptions or drivers. This task is assumed, in general, by specialized service providers. The service is the development and maintenance of the integration means. For development- and maintenance tasks, it is necessary to establish digital communication with the field device. In process automation, there are far beyond a thousand different device types of field devices, with a multiplicity of variants. This means high cost for keeping an inventory of all field devices and their variants at the service provider.

An object of the invention is to provide a method, with which remote servicing of a field device is possible beyond the limits of provisions for secured communication.

The object is achieved by a method including steps as follows:
establishing a first communication connection between the field device and a gateway associated with the first network;
establishing a second communication connection between the first gateway and an Internet addressable, broker server via an unsecured access of the first gateway;
reporting of the first gateway at the broker server; granting a unique identifier by the broker server for the first communication connection between the first gateway and the broker server;
transmitting the unique identifier to a second gateway associated with the second network;
establishing a third communication connection between the second gateway and the broker server using the unique identifier;
establishing a communication connection between the second gateway and the first gateway, wherein the broker server logically connects the second communication connection with the third communication connection, so that communication connection between the servicing device and the field device is produced.

The solution of the invention provides advantages as follows:
By creating an opportunity purposely and, with targeting, to surmount predetermined limits of local network structures (LANs), the reaction times and costs for service are drastically reduced.
By creating an opportunity for surmounting predetermined limits of local network structures (LANs), the need to keep local inventories of field devices can be reduced. In this way, development- and maintenance costs can be greatly reduced.

An advantageous further development of the method of the invention provides that communication connection between the servicing device and the field device is established via standard HTML. Especially, protocol-specific data and/or picture data of a webcam, especially device-specific picture data, are transmitted via the communication connection. In this way, the service provider has the opportunity, remotely, to make a picture of the situation on-site. Since the protocol-specific data and/or the picture data can be security-critical data, it is provided that the data can be transmitted encrypted.

An advantageous embodiment of the solution of the invention provides that the two gateways establish communication connections to the broker server via a port usually open in firewalls, e.g. port 80. Furthermore, it is provided that the two gateways are provided as hardware solutions and/or as software solutions.

An advantageous embodiment of the method of the invention provides that the time synchronization of the gateways is performed via the broker server, wherein the time sequences of communication connections are logged and/or communication transit times on the individual communication connections measured. Especially, the logged communication connections can be used to simulate the interaction of a direct connection between the servicing device and the field device in the form of playback of the recordings under real time conditions.

The creation of the first communication connection and/or the second communication connection occurs either automatically or via user on-site.

Furthermore, it is provided in connection with the invention that the transmitting of the unique identifier to the second gateway occurs automatically or manually by user in the first network and in the second network, wherein established communication means, e.g. email, telephone, SMS, etc. are utilized for the transmission.

Regarding the system for performing the method of the invention, it is provided that the first network involves a secured company network of the owner of the field device, that the second network is a secured company network of a service provider, and that the broker server is reachable via Internet. In this way, a worldwide accessing of the field device is assured.

The invention will now be explained in greater detail based on the appended drawing, the figures of which show as follows:

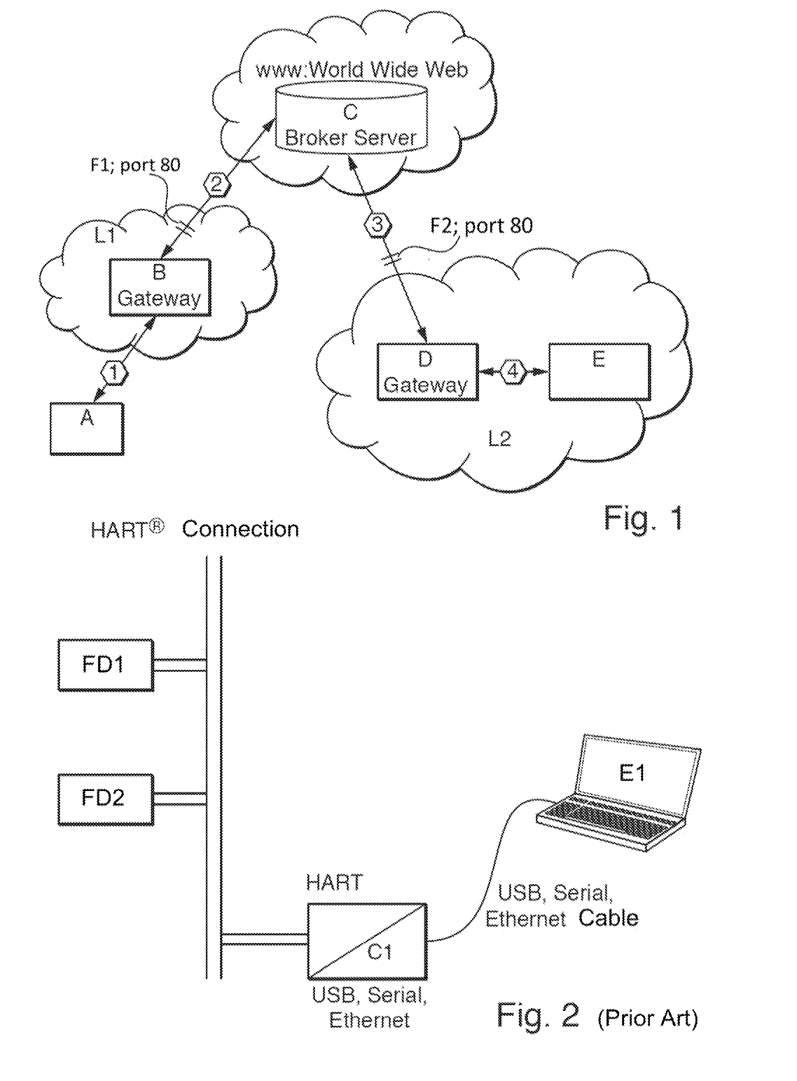

FIG. 1 subject matter of the invention, wherein data communication between a servicing device E in a remotely arranged advising- and/or developing station and a field device A is provided; examples of field devices have already been given above; and

FIG. 2 a known system for remote servicing of two field devices FD1, FD2 using the HART protocol and a two conductor connection.

FIG. 2 has already been explained in the introduction. With reference to FIG. 1, in order to enable a communication connection 1, 2, 3, 4 beyond the limits of the secured network (LAN) L2 of a service provider and of the secured network (LAN) L1 of the user of the field device A, two gateways B, D are required. These establish communication connections, for example, via standard HTML. Since direct communication connection between the gateways B, D is, in general, blocked by the firewalls F1, F2, a broker server C is placed in the World Wide Web. The two gateways B, D can exchange data via the broker server C. Besides protocol-specific data, such as parametering- or diagnostic data, for example, also graphical data of a webcam can be transmitted securely and encrypted via the communication connection 1, 2, 3, 4. Preferred device-specific pictorial material includes, for example, pictures of an on-site display (not shown) associated with the field device A.

Preferably, the implementing of communication connection between the gateways B, D occurs via the broker server C by means of HTML POST and/or HTML GET methods. Starting with HTML 5, also HTML sockets can be applied. As already mentioned above, the gateways B, D can be implemented as hardware- and/or software components.

A time synchronizing of the gateways B, D via the broker server C is utilized to log very precisely the time sequence of the data communication and especially to measure communication transit times on the individual communication paths 1, 2, 3, 4. The logged recordings are used in both gateways B, D, in order to simulate the interaction of a direct communication connection 1, 2, 3, 4 between the field device A and the servicing device E in the form of a playback of the recordings under real time conditions.

The establishing of the connection occurs according to the invention with steps as follows:

1. Gateway B creates communication connection 1 with the field device A. The establishing of communication connection occurs either automatically or by a user on-site, wherein communication connection 1 can occur directly or indirectly via infrastructure on-site. For example, communication occurs using the HART protocol. The gateway B can be embodied as a hardware solution or as a software solution.

2. Gateway B connects with the broker server C, wherein communication connection 2 is implemented via components, which can be used without danger to the LAN L1 of the owner. Thus, the components are not blocked by the protective mechanisms, especially the firewall F1, of the LAN L1. In the case of use of the HTML standard, this involves a suitable component, for example, port 80. Establishment of the connection occurs either automatically or manually by a user. The gateway reports at the broker server C and obtains from the broker server C a unique identifier, which designates the communication connection 2.

3. The unique identifier is transmitted to gateway D. Again, the transmitting of the unique identifier is done by the user for both LANs L1, L2 automatically or manually. The transmitting of the unique identifier occurs by means of established communication means such as telephone, email, SMS, etc.

4. Gateway D now establishes a communication connection 3 with the server C preferably in the World Wide Web WWW by entering the unique identifier, wherein communication connection 3 utilizes communication means, which are also utilized for establishing communication connection 2.

5. The broker server C now logically connects communication connections 3, 2 and provides therewith for frictionless data traffic between gateway B, respectively field device A, and gateway D, respectively the servicing device E.

6. Broker server C and gateway D can now exchange data, wherein, preferably, data encryption is used. As already stated, besides protocol data, also other data, such as e.g. picture data, can be transmitted.

1-11. (canceled)

12. A method for remotely servicing a field device of automation technology located in a first network secured by a first firewall, wherein remote servicing occurs via a servicing device associated with a second network secured by a second firewall, wherein the method comprises steps of:
establishing a first communication connection between the field device and a gateway associated with the first network;
establishing a second communication connection between the first gateway and an Internet addressable, broker server via an unsecured access of the first gateway;
reporting of the first gateway at the broker server;
granting a unique identifier by the broker server or the first communication connection between the first gateway and the broker server;
transmitting the unique identifier to a second gateway associated with the second network;
establishing a third communication connection between the second gateway and the broker server using the unique identifier; and
establishing a communication connection between the second gateway and the first gateway, wherein:
said broker server logically connects the second communication connection and the third communication connection with one another, so that communication connection between the servicing device and the field device is produced.

13. The method as claimed in claim 12, wherein:
communication connection between the servicing device and the field device is established via standard HTML.

14. The method as claimed in claim 12, wherein:
the two gateways establish their communication connections to said broker server via a port usually open in said firewalls.

15. The method as claimed in claim 12, wherein:
protocol-specific data and/or picture data of a webcam, especially device-specific picture data, are transmitted via said communication connection.

16. The method as claimed in claim 15, wherein:
said protocol-specific data and/or said picture data are transmitted encrypted.

17. The method as claimed in claim 12, wherein:
the two gateways are provided as hardware solutions and/or as software solutions.

18. The method as claimed in claim 12, wherein:
time synchronization of the gateways is performed via said broker server; and
time sequences of communication connections are logged and/or communication transit times on the individual communication connections measured.

19. The method as claimed in claim 18, wherein:
the logged communication connections are used to simulate the interaction of a direct communication connection between the servicing device and the field device in the form of a playback of the recordings under real time conditions.

20. The method as claimed in claim 12, wherein:
the creation of the first communication connection and/or the second communication connection occurs automatically or via a user on-site.

21. The method as claimed in claim 12, wherein:
the transmitting of the unique identifier to the second gateway occurs automatically or manually by a user in the first network and in the second network; and
established communication means, e.g. email, telephone, SMS, etc., are utilized for the transmission.

22. A system for performing the method as claimed in claim 12, wherein:
the first network involves a secured company network of the owner of the field device;
the second network is a secured company network of a service provider; and
said broker server is reachable via Internet (WWW).
